(19) United States
(12) Patent Application Publication
(10) Pub. No.: US 2024/0424493 A1
(43) Pub. Date: Dec. 26, 2024

(54) MICROFLUIDIC DEVICE FOR SAMPLE ENCAPSULATION AND METHOD FOR OPERATING THEREOF

(71) Applicant: ECOLE POLYTECHNIQUE FEDERALE DE LAUSANNE (EPFL), Lausanne (CH)

(72) Inventors: Philippe RENAUD, Preverenges (CH); Jiande ZHOU, Lausanne (CH)

(21) Appl. No.: 18/708,216

(22) PCT Filed: Nov. 11, 2022
(86) PCT No.: PCT/EP2022/081677

§ 371 Date: May 8, 2024

(30) Foreign Application Priority Data
Nov. 12, 2021 (EP) 21208067.5

(51) Int. Cl. B01L 3/00

(52) U.S. Cl. CPC B01L 3/50273; B01L 3/502761; B01L 3/502784; B01L 2200/0652; B01L 2200/12; B01L 2300/0838; B01L 2300/0864; B01L 2400/0406

(57) ABSTRACT

The invention relates to a microfluidic device (3) comprising: —an inlet channel (31) having an inlet configured to be operatively connected with a droplet source (2) wherein the inlet channel (31) has a width wᵢ and height hᵢ; and —an outlet channel with at least one outlet channel branch (32) operatively connected with the inlet channel (31) at a passage point (33), said outlet channel (32) having a width wₒ, wherein the width wₒ of the at least one outlet channel branch (32) and the height hᵢ and the width wᵢ of the inlet channel (31) satisfy a geometrical condition of formula (I), said z>1.

### TECHNICAL FIELD

The present invention relates to microfluidics, in particular to generating microdroplets encapsulating samples such as microparticles, cells, or any other deformable samples and sorting the microdroplets using droplet-based microfluidic devices encapsulating samples in an efficient manner.

### TECHNICAL BACKGROUND

Precision biological cell handling tools are needed in research and production to enable efficient manipulation of cells or other samples. Current methods for single cell encapsulations in droplets, for instance, are inefficient and waste costly materials. Particularly, the separation of cells from a carrier fluid into microdroplets not much larger than the cell itself, allows a simplified further processing of the cells in succeeding microfluidic modules configured to manipulate discrete droplets.

In general, droplet-based microfluidic devices can be configured to perform a variety of operations such as transportation of droplets, storage of droplets, mixing of droplets, analysis of droplets and the like. For example, these devices can be used as microreactors to encapsulate various biological entities for biomedicine and biotechnology applications.

Droplet-based single cell assays are based on the ability to encapsulate and confine single cells in individual droplets and e.g. enable high efficiency genome-wide expression profiling. For instance, encapsulation of one-cell-one-bead in droplets is an essential operation for high throughput screening of single cells and droplet sequencing for e.g. transcriptomic analyses.

Matula, Kinga, Francesca Rivello, and Wilhelm T S Huck. “Droplet Microfluidics: Single-Cell Analysis Using Droplet Microfluidics (Adv. Biosys. 1/2020).” Advanced Biosystems 4.1 (2020): 2070012 review the various droplet microfluidic strategies reported in the literature, with a focus on approaches to targeted-and whole-genome analysis in droplet-encapsulated single cells, as well as whole-transcriptome profiling techniques. Si Da Ling, Yuhao Geng, An Chen, Yanan Du, and Jianhong Xu, “Enhanced single-cell encapsulation in microfluidic devices: From droplet generation to single-cell analysis”, Biomicrofluidics 14, 061508 (2020), https://doi.org/10.1063/5.0018785 explore the field of single-cell encapsulation and analysis, and provide an overview of the droplet formation mechanism, fabrication methods of microchips, and several of passive and active encapsulation techniques to enhance single-cell encapsulation. However, as most of the techniques for passive single cell encapsulations in droplets are performed randomly under the regime of Poisson statistics, the number of cells inside each droplet is generally unknown, raising major concerns for downstream analysis, including e.g. quantification, screening, merging for one-bead-one-cell and/or one-cellA-one-cellB encapsulation. Moreover, potential harm toward encapsulated cells, meticulous manipulation of flows or very long operation time may further happen during implementation of such passive methods. Accordingly, one major challenge in performing droplet sequencing is achieving high efficiency for one-droplet-one-cell or one-cell-one-bead encapsulation, while preferably operating with high-throughtput and safeguard of the sample.

It is an object of the present invention to provide a microfluidic device for encapsulating deformable samples such as cells, microparticles of the like in microdroplets which can be easily separated from empty droplets, in such way to deterministically obtain single deformable samples in each droplet, i.e. sample droplets. In an additional aspect, the device and method according to the invention can be suitably used for producing child droplets, i.e. sampleless droplets, deriving from the breakup of a parent droplet, that is, for splitting a droplet into different sizes of child droplets.

It is a further object of the present invention to provide a microfluidic device which allows to separate sample droplets including deformable samples from empty droplets in a reproducible manner.

### SUMMARY OF THE INVENTION

This object has been achieved by the microfluidic device according to claim 1, the microfluidic system and a method for operating the microfluidic device according to the further independent claim.

Further embodiments are indicated in the dependent subclaims.

According to a first aspect of the present invention, a microfluidic device is provided comprising a droplet-splitting junction. The droplet-splitting junction comprises:
an inlet channel having an inlet configured to be operatively connected with a droplet source wherein the inlet channel has a width wᵢ and height hᵢ; and
an outlet channel with at least one outlet channel branch operatively connected with the inlet channel at a passage point, said outlet channel having a length N, a width wₒ and a height hₒ,
wherein the width wₒ of the outlet channel and the height hᵢ and the width wᵢ of the inlet channel satisfy a geometrical condition of

$$z = \frac{2}{{w}_{o}} / ( \frac{2}{{h}_{i}} + \frac{2}{{w}_{i}} ) ,$$

said z>1.

Furthermore, an aspect ratio may be defined as λ=hᵢ/wᵢ said aspect ratio is λ>1, wherein particularly said aspect ratio is 1<λ<10.

Also, a width ratio may be defined as φ=wᵢ/wₒ, said width ratio is φ>1, wherein particularly said width ratio is 1<φ<10.

In one embodiment, two outlet channel branches may be provided which extend perpendicularly with respect to said inlet channel.

The passage point may correspond to an intersection P which acts as a droplet-splitting junction for droplets passing the breakup point and which may be located in the center of the outlet channel, thereby separating the outlet channel into the two equal outlet channel branches.

Furthermore, the outlet of each outlet channel branch may be connected with a channel portion with a widening cross-section with an inclination angle of at least one channel wall of between 1 to 30°.

Only one outlet channel branch may be provided, wherein the outlet channel branch is running coaxially to the inlet channel.

The microfluidic device may be comprised in a microfluidic system. The microfluidic system may be operatively connected with a droplet source, wherein the droplet source provides parent droplets of a sample fluid floating in a carrier fluid, wherein the sample fluid and the carrier fluid are non- or minimally mixable, wherein particularly the sample fluid is a watery solution and the carrier fluid is an oil or wherein the sample fluid is an oil and the carrier fluid is a watery solution.

According to a further aspect, a method for operating the above microfluidic device for producing sample droplets is provided, wherein a parent droplet of a sample fluid in a carrier fluid is flown through the inlet channel to the intersection, wherein flow rate, parent droplet length and capillary number are selected to promote a central breakup of the droplet thread at the intersection, wherein flow rate, parent droplet length and capillary number are further selected so that when a deformable sample is included in the parent droplet the central breakup of the droplet thread is delayed so that a breakup occurs instead in at least one of the outlet channel branch downstream the intersection thereby forming a small sample droplet and at least one larger child droplet.

According to a further aspect a method for setting up operation of the above microfluidc device is provided, wherein parent droplets of a sample fluid in a carrier fluid are flown through the inlet channel to the passage point, wherein flowrate, parent droplet length, and capillary number are selected to promote a breakup of the droplet thread at the passage point wherein at least the parent droplet length and capillary number are selected by the steps of:
while flowing parent droplets through the inlet channel, varying both the parent droplet length and the capillary number to observe different potential breakup regimes for each combination of droplet length and capillary number;
associating breakup regimes for the combinations of droplet lengths and capillary numbers in a mapping thereby forming a transition range separating the combinations of droplet lengths and capillary numbers with different breakup regimes;
selecting a parent droplet length and a capillary number which is above the transition range by about 10 to 30% of the droplet length associated with the selected capillary number.

With the geometric condition the above method allows to find an operating point in terms of droplet length and capillary number which can be varied by the flowrate once the kind of droplet fluid and carrier fluid are chosen.

The capillary number is the total effect of viscosity, surface tension and flowrate. Capillary number (Ca) can be tuned by adjusting the flowrate once the sort of fluids is fixed which determine viscosity and surface tension. The critical capillary number regarding a transition from central breakup to a lateral or step breakup in at least one outlet channel branch (for a given length of droplet) should be fixed as long as the geometry is fixed.

According to a further embodiment, the parent droplet may contain a deformable sample which has a cross-section that corresponds to a critical dimension (smaller value of width and height) of the outlet channel or has a cross-section of between 90% and 200% of the critical dimension of the outlet channel, wherein the sample is compressible under exertion of an external force to a cross-section across the critical dimension of the outlet channel which has a size of 40 to 95% of the cross-section of the non-compressed sample. Basically, the sample may be more rigid or more viscous than the fluid of the droplet.

To operate the above microfluidic device, parent droplets are supplied through the inlet channel which may possibly contain deformable samples, such as biological cells, micro-organisms, microparticles, pollens, deformable beads, or the like. At low to medium capillary numbers, i.e. less than a critical capillary number, the inflowing parent droplets experience a lateral break-up in the outlet channel branches after having passed the intersection at the droplet-splitting junction.

The capillary number (Ca) is defined as a dimensionless quantity representing the relative effect of viscous drag forces versus surface tension forces acting across an interface between two immiscible liquids. The critical capillary numbers depend on the droplet length and the aspect ratio h/wo of the outlet channel branch as well as the width ratio wi/wo of the inlet and outlet channel. The critical capillary number Ca_{crit} is given with respect to a ratio of the droplet length L in the inlet channel and the width wₒ (normalization) of the outlet channel by L/wₒ=q/Ca_{crit}, where q may be between 0.1 and 30, preferably between 0.1 and 10. The critical capillary number Ca_{crit} depends on the aspect and the width ratios wherein the larger the aspect ratio or the width ratio are, the higher is the critical the capillary number Ca_{crit} for the same droplet length L.

The lateral break-up is characterized by necking and separation of the droplet downstream the intersection where the parent droplet has been split. To reduce the stress on incoming samples a widening channel portion may be provided with a widening cross-section with an inclination angle of at least one channel wall of between 1 and 30°. In other words, the lateral breakup defines a dividing of the split droplet in each of the outlet channel branches. When the capillary number exceeds the critical capillary number Ca_{crit} which depends on the droplet length L, the droplet will experience a central break-up instead of the lateral breakup.

The central break-up is characterized by necking and separation of the droplet directly at the intersection where the parent droplet is divided into the different outlet channel branches. The central break-up process occurs simultaneously with the development of the lateral break-up process in the background and stops by the preemptive occurrence of the central break-up.

The overall operation regime for the proposed configuration shall be the central break-up regime that is close to the transition into the lateral breakup regime. This transition is caused/determined by a time competition of central breakup regime and the lateral breakup regime. This means that although the break-up fate for any incoming droplet is the central break-up, the underlying lateral break-up process is also nearly accomplished, which is achieved when the process is carried out close to the critical capillary number Ca_{crit}, i.e. within a range of 0 to 50% above the critical capillary number Ca_{crit}.

It has been found that when a parent droplet contains a deformable sample such as a biological cell, the cell is temporarily detained at the intersection due to its larger size than the outlet channel branches. This leads to an increase of pressure at the intersection which delays the central breakup and shifts the breakup mode to the lateral breakup. The lateral breakup dominating the central breakup has the result that a small satellite droplet, a sample droplet, around the intersection is created which is a droplet that confines the sample. Substantially at the same time, two large child droplets are formed from the same parent droplet. They also have a similar size as those which would have been created from a central break-up for any parent droplets not containing samples.

One major advantage of this microfluidic device together with its operating method is that the sample droplets containing samples are much smaller in size than the child droplets which are formed by the lateral break-up. The size difference is essential, as the sample droplets containing the deformable samples can be easily separated from the large child droplets in a succeeding sorting module which may be part of the microfluidic system.

As a precondition, to enable an operation of the microfluidic device close to the transition between lateral break-up and central break-up, the microfluidic device has to be geometrically configured to reliably/robustly work in the lateral break-up regime. It has been found that a droplet splitting junction should have an aspect ratio between height ho and width wₒ of the outlet channel and a width ratio of the width wᵢ of the inlet channel and the width wₒ of the outlet channel both larger than 1.

In addition, the relation of

$$z = \frac{2}{{w}_{o}} / ( \frac{2}{{h}_{i}} + \frac{2}{{w}_{i}} )$$

with z>1 should be fulfilled. This relation reflects that when ho>wₒ is fulfilled, the limiting dimension becomes wₒ, thus only wₒ appears in the z criterion.

Geometries satisfying above condition intrinsically provide enough confinement difference and thus instability in the droplet that will allow lateral break-up to occur. Increasing either of the above ratios in the geometry design will enhance the lateral break-up regime. Extremely enhanced ratios may negatively affect the operation method as they cause a too strong lateral break-up regime that is unfavorable for the process. For large width ratios, such as width ratios wᵢ/wₒ>10, no central break-up regime can be observed preventing the use of the technique. For large-aspect ratios, such as aspect ratios h/wₒ>10, it has been observed that several lateral break-ups may occur for each incoming parent droplet causing potential problems for size sorting carried out after sample droplet generation.

The performance of the microfluidic device operated according to the above method can be influenced by either increasing the aspect ratio h/wₒ or the width ratio wᵢ/wₒ. If one of the aspect ratio and the width ratio is increased, the transition curve is shifted towards higher capillary values which may increase the throughput. As described above, increasing the aspect or width ratio enhances the lateral break-up which significantly alters the relation between the break-up regimes. Basically, the operation state of the microfluidic device which is defined by the geometry of the microfluidic device as well as the operation parameters shall be selected so that the lateral and central break-up will normally occur in a timely close manner, i.e. the time gap needed to be overcome by a deformable sample temporarily stuck at the intersection is as low as possible. In general, enhancing the lateral break-up by increasing the aspect ratio and/or width ratio could possibly improve the throughput and sensitivity of the operation method.

Compared to techniques as known from prior art the proposed microfluidic device allows a robust operation for sample encapsulation where no fine tuning is required after first experimental effort for the mapping. Furthermore, the method allows an easy up-scaling because of the passiveness. Also, as the operation of the microfluidic device does not depend on the sample concentration it can be applied for a wide range of application. Basically, the widening channel portion serves to release the confinement stress for the sample (e.g., cell) to avoid damage and other adverse impacts. Therefore, the inclination angles may be within a high range of between 1-30° for one or multiple channel walls. The length of the outlet channel branch has to be selected sufficiently long for enabling the lateral breakup regime but should not be too long to avoid stress on the sample. Particularly the length N of each outlet channel branch should be related to the parent droplet length L such that 0.2<N/L<2. All combinations of these design parameters have produced the necessary breakup regime competition required by this technique.

In addition, the working principle requires that the sample to be encapsulated is retained temporarily at the intersection and will eventually pass through one of the outlet channel branches. This limits the use of the operating method to deformable samples, including but not limited to biological cells and other soft particles. Accordingly, the outlet width wo should be slightly smaller than the diameter of this sample (in addition to fulfilling the lateral breakup enabling criterion).

In an alternative embodiment, the outlet of each outlet channel branch is connected with a channel portion with a step-like widened cross-section (not with an inclination) which has at least a cross-section of more than 200% of the cross-section of the respective outlet channel branch.

In this second embodiment, the microfluidic device has no slowly widening outlet channel, but an outlet channel that adds at a wider reservoir without slowly widening its cross-section. While basically the geometry parameter and operating conditions remain as explained above, it leads to an operation mode where no lateral break-up occurs, but a step break-up when the droplets enter the reservoir formed by the widened channel portion. The step break-up is defined that instead of a lateral breakup a breakup occurs when the child droplet enters the wider channel portion. In the wider channel portion the child droplet starts to form a bulk that will grow with time with increasing radius. This bulk connects to the main thread of the child droplet in the respective outlet channel branch through a neck near the step-like widening of the outlet channel branch into the channel portion.

Due to the pressure drop between the neck and the bulk, the curvature of the bulk decreases due to the growth of the bulk. This increases the pressure difference so that the droplet fluid flow from the neck to the bulk will increase. When the outlet flow becomes larger than the inlet flow, entering the intersection the neck will become thinner and thinner and eventually leads to the break-up at the step-like widening into the channel portion.

The earlier the bulk starts to form, which can be achieved by a longer droplet or shorter length of the outlet channel branch, step break-up will be more prominent. On the contrary, when the capillary number is large (e.g. above a critical capillary number which may be determined experimentally), especially during central break-up, then the separation fluid, e.g. oil pinches the interface at the intersection and pushes the droplet thread into the outlet channel branches, the flow entering the inlet channel is high, compensating the necking effect. As a result, the process of the step break-up will cease and only central break-up will occur.

At the target flow condition, the parent droplet passing the intersection will experience central break-up, while the flow entering the intersection and the flow after the stepwise widening of the outlet channel is such that the step break-up is almost achieved, but is canceled by the occurrence of a central break-up.

When a supplied parent droplet contains a deformable sample, the sample obstructs the intersection which will see an enormous increase in resistance, thus significantly reducing the flow entering through the intersection first into both outlet channel branches and then in only the one outlet channel branch through which the sample is flowing. When the outlet flow of the obstructed outlet channel branch remains constant, the necking process can re-boost, and step break-up will eventually happen at the respective channel portion through which the deformable sample will pass.

In contrast, the other outlet channel branch which has not been obstructed with the deformable sample, experiences an increasing flow through the intersection compared to cases in which no deformable sample is included in the parent droplet. The necking will still be compensated preventing the step break-up process. Finally, the deformable sample will be encapsulated in a small droplet generated in one of the outlet channel branches due to the central break-up and a child droplet formed by a step break-up on the respective other outlet channel branch. The deformable sample is therefore caught between two empty child droplets originating from the same parent droplet. The size of the sample droplet is only determined by the geometry of the length of the outlet channel branches and the height of the outlet channel branches.

As described above in conjunction with the working scheme between the central breakup and the lateral breakup not all microfluidic devices with a droplet-splitting junction can produce the step breakup regime. However, in contrast to the working principle of the microfluidic device with the slowly widening channel portion, each parent droplet including a sample experiences different breakup schemes consisting of a step breakup and a central breakup. This is because these competing breakup regimes occur geometrically far apart, and achieving one will not necessarily stop the other. In fact, there is never a stand-alone step breakup it is always accompanied with one last breakup close to the intersection: be it a central breakup or a lateral breakup (which one exactly depends on the same physics as described before).

On the contrary, it is possible to have only the central breakup in the scheme—It just requires the flow from the intersection pushes the droplet thread enough such that the step breakup process is suppressed and cannot accomplish before the central breakup finally finishes. In fact, the ideal scheme as explained above is that for all parent droplets the central breakup occurs, but the development of the step breakup is also timely close but interrupted by the central breakup.

Such scheme requires geometric conditions and a specific operating method. It has been found that the geometric conditions require that the outlet channel branches connect to the widened channel portion forming a wider chamber at both ends of the outlet channel branches thereby creating the step. In addition, the aspect ratio h/wₒ should be large enough.

According to a further embodiment, just one outlet channel branch may be provided, wherein the outlet channel branch is running coaxially to the inlet channel.

According to a further embodiment, the droplet source comprises a droplet generating unit operatively connected with a reservoir and with the inlet of the inlet channel. Particularly, an operatively connected pressure source may be configured to apply pressure inside the microfluidic device to move a parent droplet from the droplet source towards the passage point.

In a further embodiment, the microfluidic system may further comprise merging channels connected with the outlets of the outlet channel branches to merge the droplet flow through the outlets of the outlet channel branches into a merging point. For instance, the merged droplet flow may be fed to a sorting module for sorting the droplets by size to filter out smaller sample droplets generated by the microfluidic device from larger child droplets.

It may be provided that the above microfluidic device or the above system are used for the production of sample droplets as droplets containing a deformable sample included in a parent droplet and deriving from the breakup of a parent droplet into at least one child droplet in at least one outlet channel branch downstream the passage point.

According to a further embodiment, the above microfluidic device or the above system may be used for the production of droplets from a parent droplet and deriving from the breakup of the parent droplet into at least one child droplet in at least one outlet channel branch downstream the passage point.

According to a further aspect, a method for operating the above microfluidic device for producing sample droplets is provided, comprising the step of:
flowing a parent droplet of a sample fluid in a carrier fluid through the inlet channel to the intersection, wherein flow rate, parent droplet length, and capillary number are selected to promote a central breakup of the droplet thread at the intersection;
   wherein flow rate, parent droplet length, and capillary number are further selected so that when a deformable sample is included in the parent droplet the central breakup of the droplet thread is delayed so that a breakup occurs in at least one of the outlet channel branches downstream the intersection thereby forming a small sample droplet and at least one larger child droplet.

According to an embodiment, the parent droplet may contain a deformable sample which has a cross-section that corresponds to a critical dimension of the outlet channel or has a cross-section of between 90% and 200% of the critical dimension of the outlet channel, wherein the sample is compressible under exertion of an external force to a cross-section across the critical dimension of the outlet channel which has a size of 40 to 95% of the cross-section of the non-compressed sample.

Furthermore, a separation module may be provided, where the separation module comprises:
a receiving inlet being in direct communication with an outlet opening of the at least one outlet channel branch to receive sample droplets being droplets including a deformable sample and sampleless droplets which are empty droplets with a constant velocity or flow rate;
a separation chamber directly connected to the receiving inlet and having an asymmetric shape of a cross-section between two walls being in direct communication with the receiving inlet with respect to the axial direction of the at least one outlet channel branch;
a separation element configured to separate sample droplets and sampleless droplets travelling on different trajectories.

This separation module can be applied to any microfluidic devices providing both sample droplets and sampleless droplets in a continuous carrier fluid stream, such as microfluidic devices as described above. Instead of from the outlet channel branch droplets can be received from any outlet openings providing such mixture of sample and sampleless droplets.

Moreover, the separation chamber may be directly connected to the receiving inlet and having a first wall extending with a first angle of between 0° and 45° with respect to an axial direction of the at least on outlet channel branch at the outlet opening and an opposing second wall extending with a second angle with respect to an axial direction of the at least on outlet channel branch at the outlet opening which is larger than the first angle.

The separation element may be formed as a structure with separation walls located between the trajectories of the sample droplets and the child droplets, wherein the wall particularly separates different droplet channels for the sample droplets and the sampleless droplets.

For the afore-mentioned embodiments, there is a further task to separate sample droplets from sampleless droplets in a reproducible manner. The droplet separation may be based on a newly found effect which occurs if the outlet channel from which sample droplets and sampleless droplets are released, extends into an asymmetric separation chamber.

The asymmetric chamber is formed in a preferred case with a first wall directly connected with the receiving inlet and having an angle of 0° and a second wall having an angle of 90° with respect to the axial direction. A droplet that relaxes quickly is pushed away from the first wall immediately when entering the receiving inlet because of the remaining contact to the first wall and the release from the channel walls of the respective outlet channel branch. If a droplet is more viscous or if its relaxation from the deformed state in the outlet channel to a substantially circular shape is retarded by any means such as presence of a sample squeezed in the narrow section of the outlet channel, the droplet propagates longer in axial direction so that it will be less deviated.

Hence, the asymmetric geometry of sidewalls of the separation chamber results in the physical turning of all droplets from axial direction to the lateral direction. Stiffer droplets turn later which means that they follow the axial direction for a longer time while softer droplet turn earlier.

As an essence of the above-described effect, while the sample and sampleless droplets moved through the outlet chamber are exerted by the dimensions of the outlet channel, the asymmetric widening of the separation chamber allows to make use of different relaxation behaviors of sample droplets and child droplets.

As am possible explanation of the effect, when the sample droplets and sampleless droplets arrives at an outlet opening at the end of the outlet channel, their deformations are substantially influenced by the presence of a deformable sample in the droplets. Sampleless droplets moving through the outlet channel have concave rear caps with interfaces attached to the walls of the separation chamber, while for sample droplets the deformable sample occupies the rear capped region which helps the rear cap withstand the concaving deformation as this region is more rigid than the corresponding region of the droplet fluid. This results in different droplet attachment behaviors to the part of the walls of the separation chamber directly abutting the outlet of the outlet channel and further influences the following droplet relaxation process and their movements.

Furthermore, what has been found is that in a separation chamber which extends from an outlet opening of the outlet channel and which has an asymmetric cross-section with respect to an axial direction of the outlet channel, the sample droplets have a higher speed vector in the axial direction of the outlet channel compared to sampleless droplets without any deformable samples. This effect also helps separating the trajectories of sample droplets and sampleless droplets.

Due to the asymmetric shape of the separation chamber, there is further a radial flow scheme of the carrier fluid originating from the outlet opening which transports the droplets also in a direction perpendicular to the axial direction of the outlet channel. This results in amplification of the initially formed different trajectories of sample droplets and sampleless droplets in the separation chamber. The separation of the droplets can then be easier achieved by including a separation wall which separates the fluid streams containing the sample droplets and the sampleless droplets, respectively.

### BRIEF DESCRIPTION OF THE DRAWINGS

Embodiments are described in more detail in conjunction with the accompanying drawings, in which:

FIG. 1 schematically shows a microfluidic system for generating sample droplets from parent droplets.

FIG. 2 schematically shows the microfluidic device in more detail.

FIGS. 3a to 3c illustrations of a lateral break-up, a central break-up, and a lateral break-up with sample droplet generation, respectively.

FIG. 4a shows a regime mapping for different droplet length and capillary numbers on an exemplary geometry according to one non-limiting example.

FIG. 4b shows a different representation of a regime mapping for different droplet length and capillary numbers and different geometrical conditions.

FIGS. 5a and 5b illustrate the operation of the microfluidic device without cell in parent droplet and with cell in parent droplet, respectively.

FIG. 6 shows the area of combinations of width ratio and aspect ratio at which a lateral breakup LB occurs.

FIG. 7 schematically shows a further embodiment of a microfluidic device.

FIGS. 8a to 8c show illustrations of a step break-up, a central breakup, and a central break-up with an obstructing sample droplet, respectively.

FIGS. 9a to 9d show diagrams indicating breakup regimes for differing capillary numbers and differing droplet lengths L.

FIGS. 10a-10d schematically show a further embodiment of a microfluidic device in different operation states.

FIG. 11 schematically shows a cross-sectional view through a separation module which allows to separate sample droplets from sampleless droplets.

### DESCRIPTION OF EMBODIMENTS

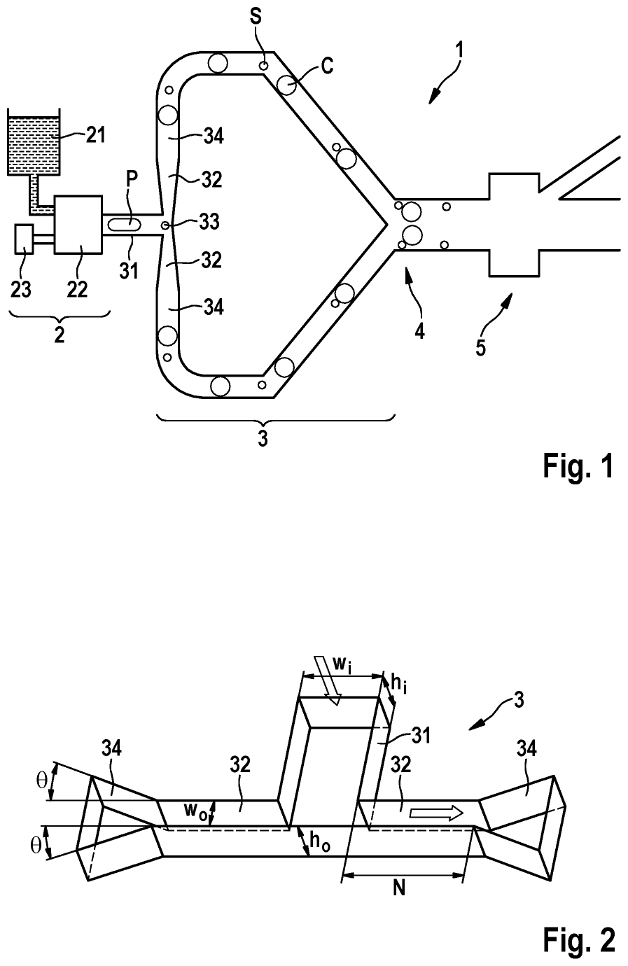

FIG. 1 shows a microfluidic system 1 according to one embodiment of the invention where sample droplets S shall be extracted from a stream of parent droplets P containing none, one or more deformable samples such as biological cells, micro- organisms, microparticles, pollens, deformable beads, or the like.

The microfluidic system 1 comprises a droplet source 2, a microfluidic device 3, a merging portion 4, and a sorting module 5.

The droplet source 2 includes a reservoir 21 which contains a sample fluid containing samples. The droplet source 2 may include a droplet generating unit 22, such as those described for instance, and without limitation, in Chong, Zhuang Zhi, et al. “Active droplet generation in microfluidics.” Lab on a Chip 16.1 (2016): 35-58, generating parent droplets P of the sample fluid. Parent droplets P are generated in a carrier fluid. The sample fluid and the carrier fluid are non-mixable or minimally mixable, wherein particularly the sample fluid is a watery solution and the carrier fluid an oil or wherein the sample fluid is an oil and the carrier fluid is a watery solution.

The droplet source 2 may comprise an operatively connected pressure source 23 configured to apply a pressure towards the microfluidic device 3 to move parent droplets P from the droplet generating unit 22 towards the microfluidic device 3.

The microfluidic device 3 is configured and operated to produce sample droplets S and child droplets C as described below. The microfluidic device basically comprises a T-junction splitting parent droplets P fed from an inlet channel 31 to two outlet channel branches 32.

The child and sample droplets C, S are produced in the two outlet channels branches and fed to the merging portion 4 where the fluid flows are mixed to merge the two separate flows into one which then is fed to a sorting module 5.

The sorting module 5 may be configured to separate droplets by size. As the sample droplets S are smaller than the child droplets C the sample droplets S containing deformable samples will be directed into one or more sample droplets collection channel and the other child droplets C into a waste collection channel. The sorting module 5 may comprise one or more electrodes that sort the droplets by dielectrophoresis (DEP) so that droplets are manipulated in non-uniform electric fields. The movement of droplets in DEP is based on the difference in polarizability between the droplets and the surrounding medium.

Furthermore, the sorting module 5 may comprise a lateral cavity across the transducer (LCAT) that sorts the droplets exploiting the phenomenon of acoustic microstreaming to manipulate fluid flow. This is e.g. described in US 2014/0011291 A1. Preferably, due to the large size difference of child and sample droplets C, S, sorting can be accomplished in a passive way, using methods like Deterministic lateral displacement (DLD) or Pinched Flow fractionation (PFF). Active sorting involving electric and/or acoustic forces is not necessary.

The microfluidic system 1, therefore, aims to separate deformable samples from threads of parent droplets P flowing through the inlet channel 31 towards the sorting module 5. The parent droplets P are supplied by a droplet source 2 including a droplet generating unit 22 providing parent droplets of a sample fluid in a carrier fluid. However, in alternative embodiments, the droplet source 2 may comprise already formed parent droplets that can be released inside the system by e.g. pumping means well known in the art.

According to a first embodiment, the microfluidic device 2 has a configuration that is shown in more detail in FIG. 2. The microfluidic device 2 has the inlet channel 31 connected with the droplet source 2 through which parent droplets P of a sample fluid are supplied. The parent droplets P may or may not contain deformable samples, such as biological cells or the like which have a cross-section that corresponds to the cross-section of the inlet channel or is similar thereto, i.e. the sample may have a cross-section of between 90% and 200% of a critical dimension (smaller one of height and width of outlet channel branches) of the outlet channel branches 32.

The deformation of the samples may be so that it can be compressed under exertion of an external force to a cross-section that has a size of 40 to 90% of the cross-section of the non-compressed sample.

As shown in more detail in FIG. 2, the inlet channel 31 ends on an intersection 33 with an end remote from the droplet source 2 wherein at the intersecting outlet channel branches are extending. Basically, at the intersection, a T-junction is formed in the shown embodiment wherein the outlet channel branches 32 extend perpendicularly in opposite directions from the inlet channel 31. The dimensions of the inlet channel 31 are given as width wᵢ and height hᵢ, while the dimensions of the outlet channel branches 32 are given as a length N, a width wₒ and a height hₒ. At the remote ends of the outer channel branches 32, the outlet channel branches 32 widen into a widening channel portion 34 with an angle θ starting from the end of the outlet channel branch 32. The length N between the intersection and the end of the outlet channel branch 32 are non-essential geometrical parameters, but can, however, influence the usage of the microfluidic device 2. Basically, the length N shall be large enough and at least 25% of the droplet length L of a parent droplet P produced by the droplet generating unit 22.

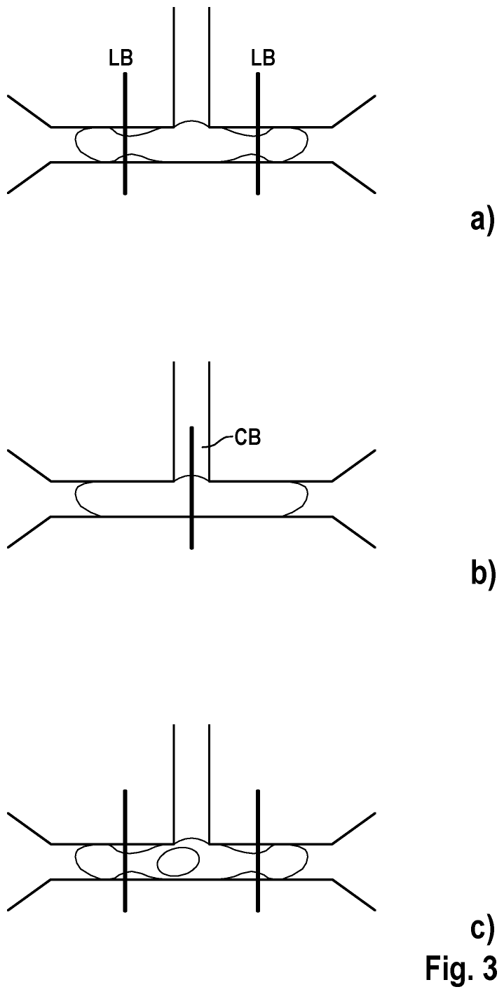

The microfluidic device 3 is operated with a low capillary number so that the parent droplets P experience a lateral breakup after passing the intersection as schematically shown in FIG. 3a. The lateral breakup, indicated by LB, is a state where necking occurs in the outlet channel branches 32 which eventually leads to a separation of droplets. There is a critical capillary number Ca_{crit} which is slightly depending on the droplet length L and which may lead to an operating regime where a central breakup CB of the droplet occurs, as exemplarily shown in FIG. 3b. The central breakup CB is defined as a necking that occurs at intersection 33 which eventually leads to a separation of droplets into the two outlet channel branches 32.

At low to medium capillary number (Ca), the parent droplets P experience a lateral breakup LB at the T junction. When above the critical capillary number, the droplet breakup fate becomes a central breakup CB. The central break-up defines a state where the droplet which has already extended into the two outlet channel branches experiences a central necking and eventually breaks up at the intersection, thereby forming two separated child droplets. While in the central breakup regime, the lateral breakup process is ongoing in the background and is canceled at the time instant of the preemptive occurrence of the central breakup CB.

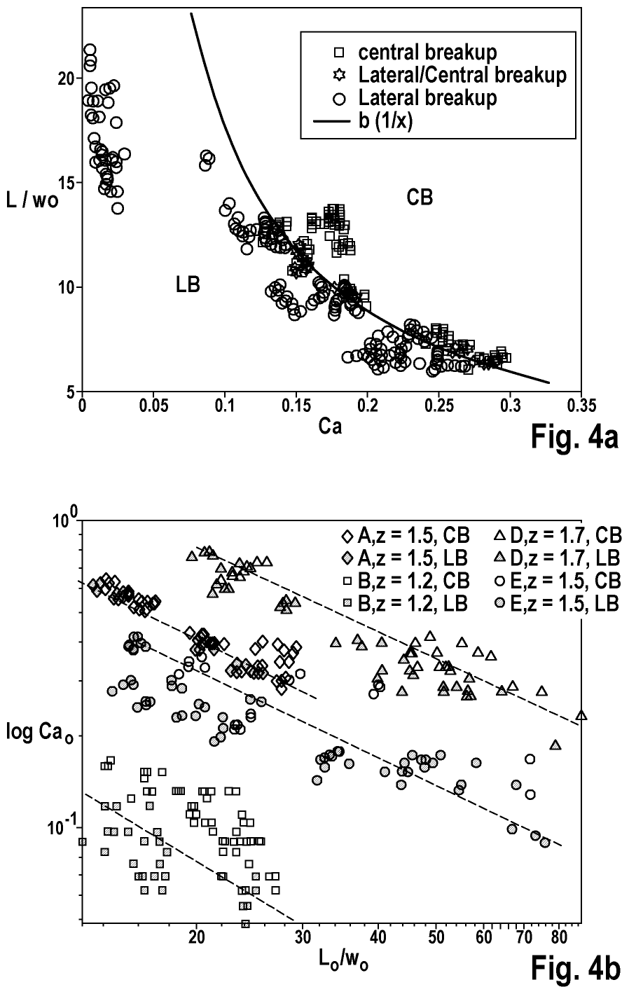

By varying the droplet length and capillary number on a T-junctions that fulfill the geometric condition, the critical capillary number for each of the droplet lengths can be determined as in a mapping shown in FIG. 4a. FIG. 4a shows a regime mapping for different droplet length (L) and capillary number (Ca) on an exemplary geometry of (wᵢ=12 um, wₒ=30 um, h=62 μm). L is normalized with wₒ, a power law can fit the transition line between lateral breakup LB and central breakup CB. To generate sample droplets S being small droplets including samples, the operation parameters are chosen from this mapping which correspond to a combination of parent droplet length L and capillary number Ca that results in central breakup that is 3-50% above the transition line. This means that the operation parameters are selected so that the lateral break-up starts developing, while the central break-up occurs timely close to the accomplishing of the lateral break-up. As a consequence, the parent droplets are supplied to be split by the central breakup CB regime that is also close to the transition as shown in the diagram of FIG. 4a. Also, a transition phenomenon where both lateral breakup LB and central breakup CB occur at the same time (three breakup locations) can be observed.

In a different representation of FIG. 4b, the axis scales are adapted (according to a power laws scale or a log-log scale) obtain as transition ranges straight transition lines for four geometries (A, B, D and E indicated by different z values see description below). Capillary number Ca and droplet length L that are obtained in the inlet channel are re-scaled with respect to the outlet channel (specified with letter “o”), which are the same for all four geometries-to be comparable among different geometries. Dashed straight transition lines illustrate the separation between the breakup regimes. The experimental data is given as solid markers for observed lateral breakups, hollow markers for central breakups.

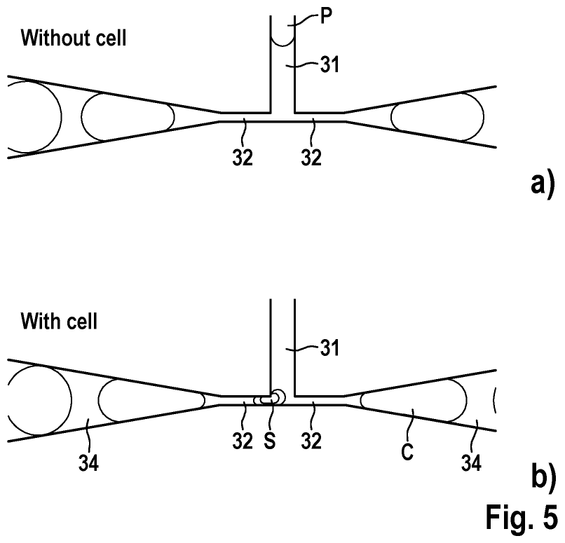

This means, although the breakup regime for any incoming parent droplet P shall be set as the central breakup, the underlying lateral breakup LB process is also nearly accomplished. This is e.g. shown in FIG. 5a.

As shown in FIG. 5b, when a parent droplet contains a cell as an exemplary sample, the cell is temporarily detained at intersection 33 due to its larger cross-section/size than the outlet channel branches. The pressure at intersection 33 is then temporarily increased, which delays the central breakup CB in time and shifts the droplet generation regime to the lateral breakup LB as schematically shown in FIG. 3c, creating a small sample droplet S around the intersection that confines the cell. At the same time, two large empty child droplets C are formed from the same parent droplet P, as shown in FIG. 5b. They also have basically a similar size as those created from the central breakup CB which will occur for any parent droplets without cells. Eventually, only the cell-containing sample droplets S will be small, which can be easily sorted out from those empty large child droplets C in the sorting module 5 by exploiting for instance its different size compared to large child droplets C, its dielectric properties or further suitable features.

To enable the lateral breakup regime, any T-junction should have both the aspect ratio (hₒ/wₒ) and the width ratio (wᵢ/wₒ) larger than 1. More specifically, a relation of

$$\frac{2}{{h}_{i}} + \frac{2}{{w}_{i}} < \frac{2}{{w}_{o}}$$

should be fulfilled. Defining a z number:

$$z = \frac{2}{{w}_{o}} / ( \frac{2}{{h}_{i}} + \frac{2}{{w}_{i}} ) ,$$

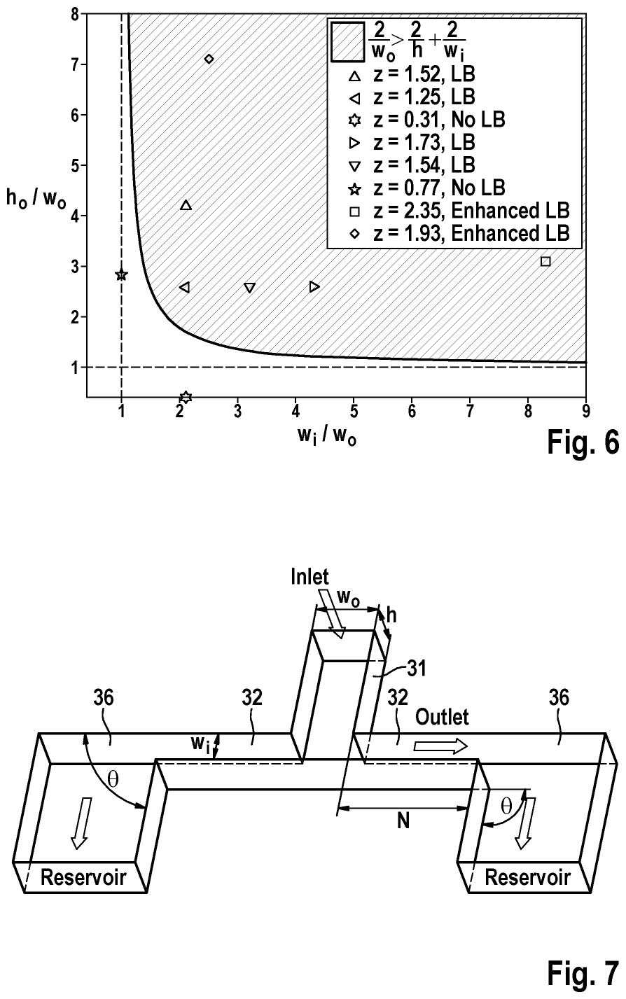

it requires z>1 to have the lateral breakup, which corresponds to the shaded region above the curve in FIG. 6. FIG. 6 shows the area of combinations of width ratio and aspect ratio at which a lateral breakup LB occurs. Geometries within this region intrinsically provide enough confinement difference and thus instability in the droplet that will allow lateral breakup to happen. Increasing either ratio in the geometry design will enhance the lateral breakup regime.

There are two ways the geometrical parameters can influence performance. One is when either aspect ratio or width ratio (or both) are increased, the transition curve is shifted towards high capillary numbers, as if the power law is timed a larger coefficient. This influences the throughput of the technique, which is increased with higher capillary numbers.

Second, as increasing either ratio would enhance the lateral breakup, such geometrical modification(s) would significantly alter the competition between the two breakup regimes. On an exemplary geometry of wᵢ=12 μm, wₒ=30 μm, h=37 μm, the time difference between the instant of achieving lateral breakup and the time instant of achieving the central breakup is so large that at any operating point close to the transition region both breakups will not occur at the same moment. However, this can be observed in the geometry of wᵢ=12 μm, wₒ=30 μm, h=62 μm. It indicates that in the latter case, the time for the lateral and central breakup process to finish is quite close, meaning the time difference needed to be overcome by a cell temporarily obstructing the intersection is reduced. Thus, the sensitivity of cell triggering breakup regime is increased.

Therefore, enhancing the lateral breakup by increasing the aspect and/or width ratio within a defined range, can improve both the throughput and sensitivity of this technique.

The other geometrical parameters of the sidewall angle θ of the channel portion and the length N of the outlet channel branch 32 only have a secondary effect. N has to be sufficiently long for the lateral breakup regime but should not be too long to avoid additional stress on the sample. The angle θ of one side wall with respect to the associated sidewall of the outlet channel branch 32 should be between 1 to 30° while the length N should be 0.2<N/L<2. All combinations have produced the necessary breakup regime competition required by this technique. However, N=25 um may be considered as the lower limit for the sample droplet generation in general applications.

In addition, the working principle requires that the sample to be encapsulated is retained temporarily at the junction and will eventually pass through the outlet channel. This limits the use of the T junction technique to deformable samples. Accordingly, the outlet width wo should be slightly smaller than the cross-section of these samples (in addition to fulfilling the lateral breakup enabling criterion).

As shown in FIG. 7, a different embodiment of the microfluidic device 3 is shown which substantially differs from the embodiment of FIG. 1 in that instead of the slowly widening channel portion 34 (with inclination angle θ) connected to the downstream end of the outlet channel branches 32, a steplike widened channel portion 36 of the outlet channel branches 32 is implemented, thereby having outlet channel branches 32 which ends in a kind of widened chamber via a step 37. Instead of a lateral break-up, a step break-up will occur at the step-like widening of the step-like widened channel portion 36.

Hence, the lateral breakup regime as described before will be completely suppressed by the chosen fluidic condition formed by the step-like widening channel portion. The step breakup is defined by a process where a droplet will be broken exactly at the step between the outlet channel branch 32 and the step-like widened channel portion 36 it is coupled with, as illustrated in FIG. 7a.

At the operational condition, it is the central breakup, as described before, and this step breakup (instead of the lateral breakup) that are dominant and in competition. Here, it can be provided a new mechanism for creating cell-triggered droplet formation, which allows to better control and increase the size of the sample droplets, with preferably higher sensitivity, without departing from the general inventive concept.

The geometrical parameters N, wᵢ, wₒ and h are defined as described in conjunction with the first embodiment. Instead of a slight expansion, there is now a wide reservoir connected to each end of the outlet channel branches, with an angle θ>80°.

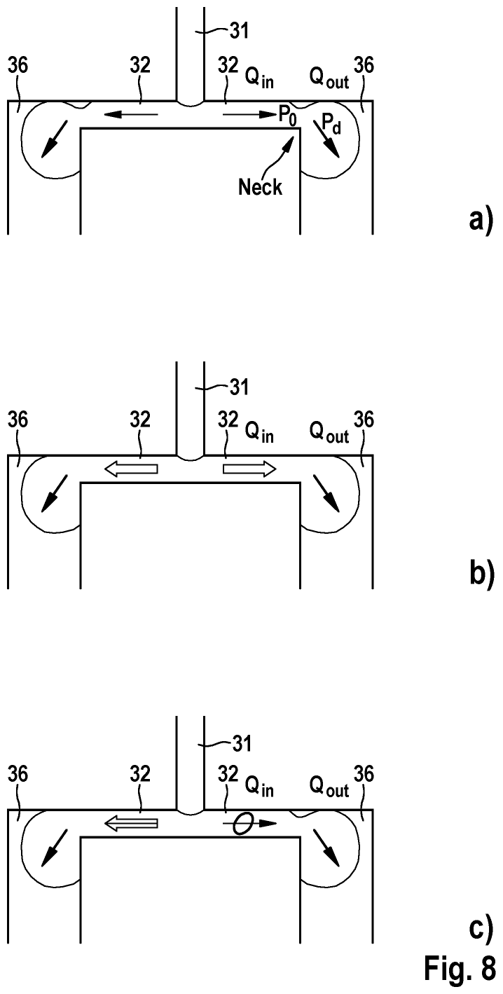

As shown in FIG. 8a, when a droplet enters the wider chamber, it starts to form a droplet bulb that will grow with time with increasing radius. This droplet bulb connects to the main thread in the outlet channel branch through a neck near step 37. The pressure drop between the neck and the bulb will increase with the decrease of the droplet curvature that is attributed to the growth of the droplet bulb. As a result, the flow Qₒᵤₜ from the neck to the bulb will increase. When flow Qₒᵤₜ is larger than the flow Qᵢₙ entering the thread from intersection 33, the neck will become thinner and thinner and eventually leads to the breakup at the step 37. The earlier the bulb starts to form, i.e., longer droplet length L or shorter outlet arm 32 (smaller N), step breakup will be more prominent. On the contrary, when the capillary number Ca is large, especially during the central breakup when the carrier fluid pinches the interface at the intersection and pushes the thread into the outlet channel branches 32, the flow entering the thread from the intersection is increased, compensating the necking effect. As a result, the process of step breakup will cease, and only central breakup will happen, as shown in FIG. 8b.

At the target flow condition, the parent droplet passing the intersection 33 will experience a central breakup, but due to the balance of the flow condition of the flow in the outlet channel branch, and the flow entering the channel portion 36, the step breakup is almost achieved but is canceled by the timely preceding occurrence of the central breakup. When a parent droplet contains a cell (as deformable sample), the cell obstructs one outlet branch after passing intersection 33, which will see an enormous increase in resistance thus significantly reduced the flow entering one of the outlet channel branches. With the flow exiting the respective outlet channel branch 32 remaining constant, the necking process can reboost, and step breakup will eventually happen in this outlet channel branch 32, as illustrated in FIG. 8c.

In contrast, the non-obstructed outlet channel branch 32 receives a higher flow compared to the process without a cell contained in the parent droplet, as an additional flow results from the obstruction of the other outlet channel branch. So, the necking will still be compensated, preventing the step breakup process in this outlet channel branch. Finally, the cell will be encapsulated in a sample droplet created by the central breakup process on one side and step breakups on both steps 33. It is caught between two significantly larger empty child droplets from the same parent droplet. The size of the sample droplet is essentially determined by the geometry, specifically the outlet channel branch length N and its height h.

Due to similar reasons, not all kind of microfluidic devices with a step at the end of the outlet channel branches 32 can produce the step breakup regime. Unlike in the first embodiment, where the droplet fate is either one of the two possible breakup regimes, in the second embodiment, there are different breakup regimes for each droplet consisting of one or more than one breakup regime. This is because these competing breakup regimes happen geometrically far apart, and achieving one will not necessarily stop the other. In fact, there is never a stand-alone step breakup, it is always accompanied with one last breakup close to the junction: be it a central breakup or a lateral breakup (which exactly depends on the same physics as described with the first embodiment.

On the contrary, it is possible to have only the central breakup in the scheme-It just requires the flow from the junction pushes enough the thread such that the step breakup process is suppressed and cannot achieve before the final central breakup. In fact, the ideal scheme as explained above is one where the central breakup actually occurs, but the step breakup development is also close to being finalized.

To enable a step breakup, the T junction needs to connect to the step-like widened channel portion at both ends of the outlet channel branches 32 creating step 37. In addition, the aspect ratio h/wₒ should be large enough.

It has been examined varying flow conditions on differing geometries. The length N of the outlet channel branch 32 equals 50 and 75 μm. Geometries of θ equal to 90°, 105°, and 120° degrees.

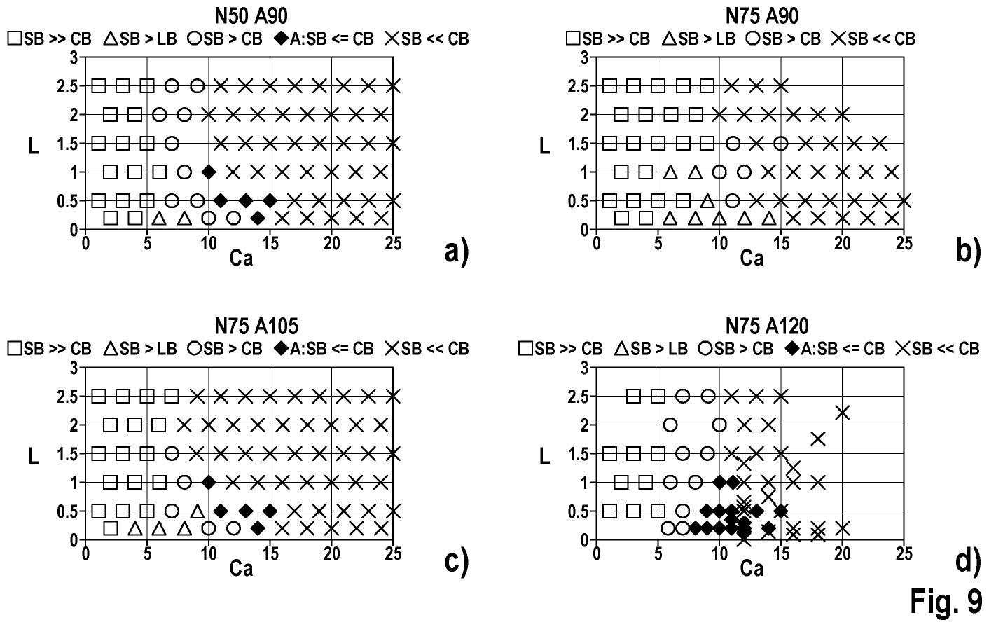

As shown in FIGS. 9a to 9d for above-mentioned geometries and from low to high capillary numbers Ca and differing droplet lengths L (normalized by the width wₒ) the droplet experiences different breakup schemes:
“SB>>CB”: step breakup (SB) is very strong, one droplet experiences a step breakup several times followed by one last central breakup (CB);
“SB>LB”: step breakup is less strong, droplet only breaks once at the step followed by one last lateral breakup (LB);
“SB>CB”: step breakup is less strong, droplet only breaks once at the step followed by one last central breakup;
“SB<=CB”: step breakup is slightly weaker than central breakup but very close;
“SB<<CB”: central breakup is completely dominant. Only central breakup occurs, and no development of step breakup can be observed.

By these patterns the best operating scheme can be found by changing the flow conditions.

It has been found that in terms of geometry, small wᵢ/wₒ and small hₒ/wₒ favor central breakup short outlet channel branch length N, large angle θ and large aspect ratio hₒ/wₒ favor step breakup. It is preferred to select the width ratio (wᵢ/wₒ) and aspect ratio (hₒ/wₒ) according to the same geometrical condition as in the first embodiment, and explore the influence of the outlet channel branch length N and the angle θ, as can be seen in FIGS. 9a to 9d.

On the first geometry N50A90 it has been found the desirable operating scheme that appears at the moderate capillary number Ca range for shorter parent droplets, as can be seen in FIG. 9a. When N is increased to 75 μm (N75A90) (see FIG. 9b) with an attempt to create a larger sample droplet, the desired operating scheme is eliminated due to the discouraging of step breakup under long outlet channel branch lengths N. To compensate the effect of high N, the angle θ can be progressively increased to 105 and 120 degrees. It is found that the desired operating scheme is back already on geometry N75A105 (see FIG. 9c) and is more prominent on geometry N75A120 (FIG. 9d).

Cell experiments demonstrate the described working principle with the successful generation of smaller droplets when and only when there is a sample in the parent droplets. Compared to the first embodiment, the cell-triggered sample droplets have sizes that increased considerably from 21 μm (first embodiment) to 25 μm (N50A90), and 35 um (N75A120) in averaged diameter.

In summary, to design a T junction that can be used in the second embodiment, a “step” structure has to be formed and the geometrical parameters N and 0 (while obeying the same geometrical rule of

$$\frac{2}{{h}_{i}} + \frac{2}{{w}_{i}} < \frac{2}{{w}_{o}} )$$

have to be tuned such that the desired operating scheme (close to transitions of breakup schemes) of droplet breakup is possible on that geometry.

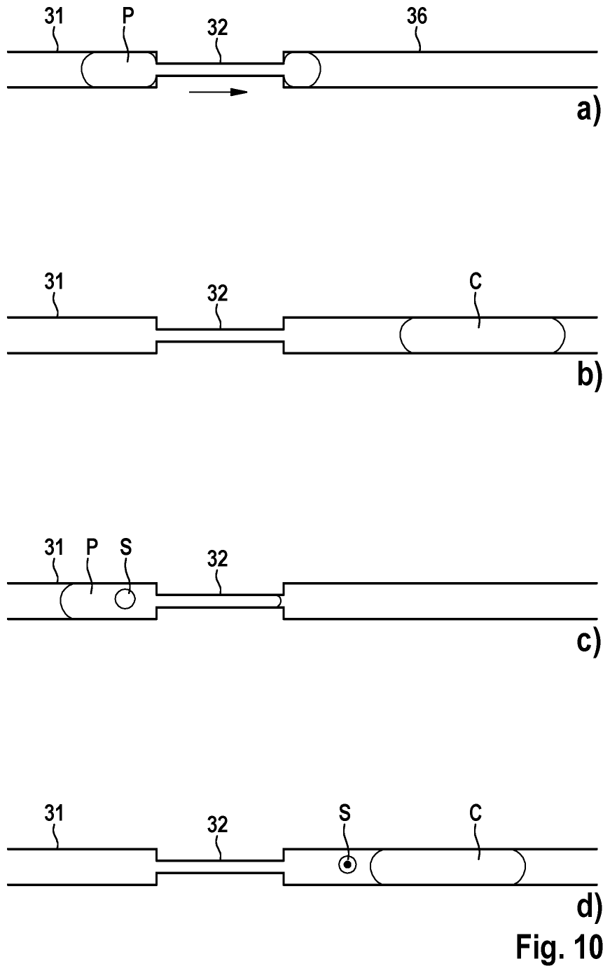

In FIGS. 10a-10d a further embodiment is illustrated. The microfluidic device 3 has an inlet channel 31 to a passage point P. From the passage point P there extends a single outlet channel branch 32 which has a decreased critical dimension. At a remote end of the outlet channel branch 32 a step-like widened channel portion 36 is connected thereby forming a straight channel.

With the straight channel, there is only a step breakup regime. On geometries that fulfill the geometric condition defined by the z number, step breakups always have the tendency to occur. The occurrence of step breakup events depends on the flow condition which is defined by the capillary number and the droplet length L. When flow rate, which affects the capillary number, is high, the droplet will already pass the passage point P before it has the time to actually finish the breakup procedure, and will become stable again (stop the tendency to break) when it enters the step-like widened channel portion 36 thereby leaving the critical part of the geometry. No breakup is effected as shown in the two subsequent operation states of FIGS. 10a and 10b where a droplet passes the microfluidic device. As shown in FIGS. 10c-10d, in the same operation conditions with a high enough flowrate, an incoming sample will trigger the operation condition back to the step breakup due to the increase of the resistance and pressure.

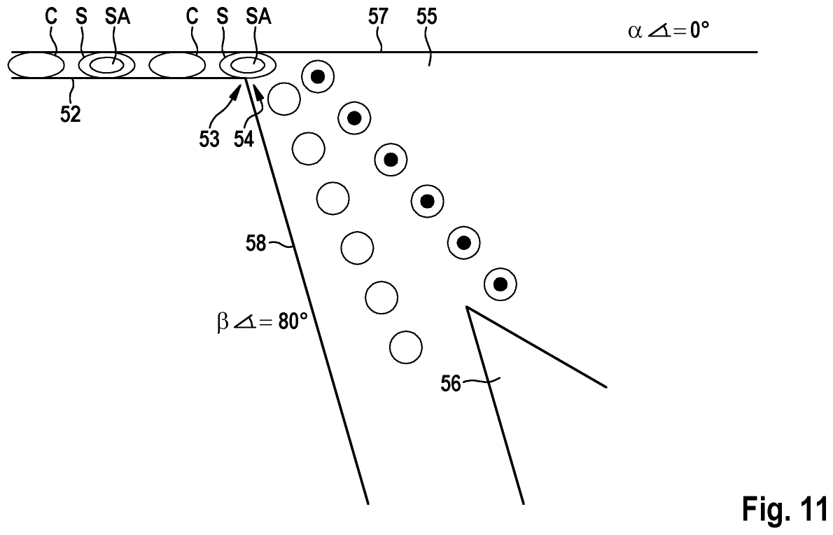

With the described embodiments, it is possible to provide deformable samples in sample droplets separated from other sampleless droplets which are empty, i.e. containing no deformable samples. The droplets are output at the outlet of the outlet channel into a receiving inlet. However, in practice, there is still a need to separate the sample droplets from the sampleless droplets. In difference to the sorting module mentioned before, a separation module may be provided which is described in the following in conjunction with FIG. 11. The separation module can be applied to any devices which provide a continuous carrier flued stream containing sample droplets and sampleless droplets.

FIG. 11 shows a cross-sectional view through a separation module 50 which allows to separate sample droplets S from sampleless droplets C only by fluidic structural measures. The separation module 50 can be applied to any droplet splitting system, which provides sample droplets S and sampleless (empty) droplets C being transported within an outlet channel 52 having dimensions which deform the droplets C, S and deform the samples SA within the sample droplets S. The dimensions hₒ, wₒ of the outlet channel may be between 10-100 μm, respectively. Particularly, at least one of the dimensions hₒ, wₒ should be selected to be able to deform a sample SA in a sample droplet. The separation module 50 directly follows the outlet opening 53 of the outlet channel 52 and is considered with a receiving inlet 54, with an expansion chamber 55 and with a droplet separator 56.

The separation chamber 55 is formed by walls receiving inlet 54 is formed by parts of the walls 57, 58 while upper and bottom walls (not shown) may be in parallel to each other to close the separation chamber. The asymmetrical expanding/widening nature at the region of the receiving inlet 54 serves to give each droplet C, S a characteristic velocity component in a lateral direction L across to the axial direction A. The characteristic velocity depends on the stiffness of the droplet and particularly on the stiffness of a deformed sample within the sample droplets S. The velocity of each droplet in axial direction A is independent of its stiffness or deformability.

In other words, sample droplets are pushed less into lateral direction than sampleless droplets thereby forming different trajectories when leaving the receiving inlet.

This effect can be explained as follows: Due to the widening nature in the region of the receiving inlet 54, the sampleless droplets remain longer in contact with the first wall 57 of the separation chamber 55 than the sample droplets S. The longer contact of the sample droplets acts against the droplet relaxation from its deformed state which they had inside the outlet channel 52. The time of droplet relaxation influences the lateral velocity of the droplets.

The widening nature of the separation chamber 55 in the region of the receiving inlet 54 therefore creates a lateral force component effected on the droplet which depends on the stiffness of the droplet and the thereby caused relaxation behavior. A stiffer droplet has more resistance to this extensional deformation (relaxation) so that it travels a longer time following the extension of the first wall 57 than the less stiff droplets (such as the sampleless droplets).

When deformation occurs as long as the droplet is still in the outlet channel, the rear cap of the droplet is deformed when the droplet comes free of the confinement of the outlet channel decides about the duration of the attachment to the outlet opening. Here, sampleless droplets have concave rear caps with interfaces attached to the first and second walls, while in sample droplets the sample occupies the rear cap region, which helps the rear cap withstand the concaving deformation as this region is now more rigid than the fluid of the droplet. This also prevents the attachment of the droplet to the second wall, and further influences the following droplet relaxation process. Eventually, provided with a constant flow rate, the sampleless droplets C are more deformed and inclined towards the second wall, whereas the sample droplets S are more resistant to the relaxing deformation and are free in the original axial direction. This results in different trajectories of the droplets starting from the receiving inlet.

In addition, due to the asymmetric cross-section of the expansion chamber 55 the streamlines of the fluid stream downstream the receiving inlet 54 are divergent what results in a spreading force on the droplets travelling on different trajectories. This leads to an amplification of the spit paths of the sample-filled sample droplets S and empty sampleless droplets C in the separation chamber 55.

Thereby, a deformation and relaxation behavior of the sample and sampleless droplets S, C can be effectively used to create different trajectories starting from the receiving inlet 54 of the separation module 50. Consequently, the presence of a deformable sample in the droplet substantially affecting its stiffness, different trajectories of sample droplets and sampleless droplets can be achieved.

The separation module 50 is mainly formed by the separation chamber 55 which directly connects with the output opening 53 of the outlet channel 52. Here, two walls of the separation chamber 55 provide a widening space, wherein the walls connect with the output of the outlet channel in different inclination angles. In the shown FIG. 11, the first and second inclination angles α, β are indicated with reference to the axial direction A so that a first wall 57 of the separation chamber 55 has a first inclination angle α of 0°, while the second wall 58 of the separation chamber 55 has a second inclination angle β of about 80°. Substantially, the first inclination angle α can be freely selected in a range between 0° and 45° while the second inclination angle β can be freely selected in a range between 30° and 160° and being larger than the first incliniation angle to provide a separation chamber 55 with an increasing cross-section for the fluid stream flowing from the receiving inlet 54 in a divergent manner.

In other words, the inclination angles of the first and second walls 57, 58 may be different, while the inclination angle of the first wall is smaller than the inclination angle of the second wall, thereby providing streamlines at the axial elongation of the outlet channel which have a stream component perpendicular to the axial direction forcing the droplets away from the axial elongation of the outlet channel 52. Due to the different lateral velocities of sample droplets and sampleless droplets this results in substantially different trajectories within the separation chamber 55.

The separating element 56 is located downstream in the separation chamber 55 and may provide a wall or similar structures which guide the sampleless droplets C and the sample droplets S travelling on different trajectories into different channels 59, thereby completing the separation of the droplets C, S.

1. A microfluidic device (3) comprising:
an inlet channel (31) having an inlet configured to be operatively connected with a droplet source (2) wherein the inlet channel (31) has a width wᵢ and height hᵢ; and
an outlet channel with at least one outlet channel branch (32) operatively connected with the inlet channel (31) at a passage point (33), said outlet channel (32) having a width wₒ,
wherein the width wₒ of the at least one outlet channel branch (32) and the height hᵢ and the width wᵢ of the inlet channel (31) satisfy a geometrical condition
$$z = \frac{2}{{w}_{o}} / ( \frac{2}{{h}_{i}} + \frac{2}{{w}_{I}} ) ,$$
said z>1.

2. The microfluidic device of claim 1, wherein an aspect ratio is defined as λ=hₒ/wₒ said aspect ratio is λ>1, wherein particularly said aspect ratio is 1<λ<10, particularly 2<λ<5, and/or wherein a width ratio is defined as φ=wᵢ/wₒ, said width ratio is φ>1, wherein particularly said width ratio is 1<φ<10, particularly 2<φ<5.

3. The microfluidic device of claim 1 or 2, wherein two outlet channel branches (32) are provided which extend perpendicularly with respect to said inlet channel (31).

4. The microfluidic device of claim 3, wherein the passage point (33) corresponds to an intersection which acts as a droplet-splitting junction for droplets passing the passage point (33) and which is located in the center of the outlet channel, thereby separating the outlet channel into two equal outlet channel branches (32).

5. The microfluidic device of any of the claims 1 to 4, wherein the outlet of each outlet channel branch (32) connects to a widening channel portion (34) with a widening cross-section with an inclination angle (θ) of at least one channel wall of between 1 to 30°, or wherein the outlet of each outlet channel branch (32) is connected with a channel portion (36) with a step-like widened cross-section which has at least a cross-section of more than 200% of the cross-section of the respective outlet channel branch (32).

6. The microfluidic device of any of the claims 1 to 2, wherein one outlet channel branch (32) is provided, wherein the outlet channel branch (32) is running coaxially to the inlet channel (31).

7. A microfluidic system (1) comprising the microfluidic device (3) of claims 1 to 6.

8. The microfluidic system (1) according to claim 7 operatively connected with a droplet source (2), wherein the droplet source (2) provides parent droplets (P) of a sample fluid floating in a carrier fluid, wherein the sample fluid and the carrier fluid are non-mixable, wherein particularly the sample fluid is a watery solution and the carrier fluid an oil or wherein the sample fluid is an oil and the carrier fluid is a watery solution, wherein particularly the droplet source (2) comprises a droplet generating unit operatively connected with a reservoir (21), e.g. comprising deformable samples such as biological cells, micro- organisms, microparticles, pollens, and deformable beads. and with the inlet of the inlet channel (31).

9. The system (1) of any of the claims 7 to 8, further comprising:
an operatively connected pressure source (2) configured to apply a pressure inside the microfluidic device (3) to move a parent droplet (P) from the droplet source (2) towards the microfluidic device (3), and/or
merging channels connected with the outlets of the outlet channel branches to merge the droplet flow through the outlets of the outlet channel branches into a merging point, wherein the merged droplet flow is particularly fed to a sorting module for sorting the droplets by size to filter out smaller sample droplets generated by the microfluidic device from larger child droplets.

10. The system (1) of any of the claims 7 to 8, comprising a separation module, where the separation module comprises:
a receiving inlet being in direct communication with an outlet opening of the at least one outlet channel branch to receive sample droplets being droplets including a deformable sample and sampleless droplets which are empty droplets, with a constant velocity or flow rate;
a separation chamber directly connected to the receiving inlet and having an asymmetric shape of a cross-section between two walls being in direct communication with the receiving inlet with respect to the axial direction of the at least one outlet channel branch;
a separation element configured to separate sample droplets and sampleless droplets travelling on different trajectories.

11. The system (1) of claim 10, wherein a first one of the two walls of the separation chamber extends with a first angle of between 0° and 60°, particularly between 0° and 45°, more preferably between 0° and 30°, with respect to an axial direction of the at least on outlet channel branch at the outlet opening and an opposing second one of the two walls extends with a second angle with respect to an axial direction of the at least on outlet channel branch at the outlet opening wherein the second angle is larger than the first angle, particularly between 60° and 180°, more preferably between 70° and 120°.

12. The system (1) of claim 10 or 11, wherein the separation element is formed as a separation structure with separation walls located between the trajectories of the sample droplets and the child droplets, wherein the separation structure particularly separates different droplet channels.

13. Use of the microfluidic device (3) of claims 1 to 6 or of the system (1) of claims 7 to 12
for the production of sample droplets (S) as droplets containing a deformable sample included in a parent droplet (P) and deriving from the breakup of a parent droplet (P) into at least one child droplet (C) in at least one outlet channel branch (32) downstream the passage point (33), or
for the production of droplets from a parent droplet (P) and deriving from the breakup of the parent droplet (P) into at least one child droplet (C) in at least one outlet channel branch (32) downstream the passage point (33).

14. A method for operating the microfluidic device (3) according to any of the claims 1 to 6 for producing sample droplets, comprising the step of:
flowing a parent droplet (P) of a sample fluid in a carrier fluid through the inlet channel to the intersection, wherein flow rate, parent droplet length (L), and capillary number (Ca) are selected to promote a central breakup of the droplet thread at the intersection;
wherein flow rate, parent droplet length (L), and capillary number (Ca) are further selected so that when a deformable sample is included in the parent droplet (P) the central breakup of the droplet thread is delayed so that a breakup occurs in at least one of the outlet channel branches (32) downstream the intersection thereby forming a small sample droplet (S) and at least one larger child droplet (C).

15. The method of claim 11, wherein the parent droplet (P) contains a deformable sample which has a cross-section that corresponds to a critical dimension of the outlet channel or has a cross-section of between 90% and 200% of the critical dimension of the outlet channel, wherein the sample is compressible under exertion of an external force to a cross-section across the critical dimension of the outlet channel which has a size of 40 to 95% of the cross-section of the non-compressed sample.

16. The method according to claim 14 or 15, wherein the flows of child droplets (C) and of sample droplets (S) from the outlet channel branches (32) are merged and the merged droplets are sorted in size to filter out the sample droplets.

17. A method for setting up operation of a microfluidic device (3) according to any of the claims 1 to 6, wherein parent droplets (P) of a sample fluid in a carrier fluid are flown through the inlet channel to the passage point (33), wherein flowrate, parent droplet length, and capillary number (Ca) are selected to promote a breakup of the droplet thread at the passage point (33) wherein at least the parent droplet length and capillary number (Ca) are selected by the steps of:
While flowing parent droplets (P) through the inlet channel (31), varying both the parent droplet length (L) and the capillary number (Ca) to observe different potential breakup regimes for each combination of droplet length (L) and capillary number (Ca);
-associating breakup regimes for the combinations of droplet lengths (L) and capillary numbers (Ca) in a mapping thereby forming a transition range separating the combinations of droplet lengths (L) and capillary numbers (Ca) with different breakup regimes;
selecting a parent droplet length (L) and a capillary number (Ca) which is above the transition range by about 10 to 30% of the droplet length (L) associated with the selected capillary number (Ca).
